(19) United States
(12) Patent Application Publication
(10) Pub. No.: US 2023/0194345 A1
(43) Pub. Date: Jun. 22, 2023

(54) RAMAN MICROSCOPE

(71) Applicant: Shimadzu Corporation, Kyoto (JP)

(72) Inventors: Naoya FUJIWARA, Kyoto (JP); Yuri ITO, Kyoto (JP)

(73) Assignee: Shimadzu Corporation, Kyoto (JP)

(21) Appl. No.: 17/994,391

(22) Filed: Nov. 28, 2022

(30) Foreign Application Priority Data
Dec. 17, 2021 (JP) 2021-205092

(51) Int. Cl. G01J 3/28; G01J 3/44; G01J 3/02; G01J 3/10

(52) U.S. Cl. CPC G01J 3/2823; G01J 3/4412; G01J 3/0237; G01J 3/108; G01J 2003/106

(57) ABSTRACT

In a Raman microscope, a depth measurement processor performs depth measurement by changing a focal position of laser light along a depth direction of a sample which is an irradiation direction of the laser light with respect to the sample, and meanwhile, acquiring a Raman spectrum of the sample at a plurality of points in the depth direction. The display processor causes Raman spectra obtained at the plurality of points by the depth measurement to be displayed. The display processor can display a surface image of the sample on the stage and a depth image representing a plurality of points in the depth direction and causes, in a case where at least one point of the plurality of points in the depth image is selected, the Raman spectrum corresponding to the at least one point to be displayed.

### CROSS REFERENCE TO RELATED APPLICATIONS

This application claims priority to Japanese Patent Application No. 2021-205092 filed on Dec. 17, 2021, the entire disclosure of which is incorporated by reference herein.

### BACKGROUND OF THE INVENTION

### Field of the Invention

The present invention relates to a Raman microscope that acquires a Raman spectrum by condensing laser light on a sample on a stage, irradiating the sample with the laser light, and receiving Raman scattered light from the sample by a detector.

### Description of the Related Art

In a Raman microscope as an example of a Raman spectroscopic instrument, laser light is condensed on a sample on a stage, the sample is irradiated with the laser light, and Raman scattered light from the sample is received by a detector (see, for example, JPH10-90064).

### SUMMARY OF THE INVENTION

In the Raman microscope as described above, a Raman spectrum at a plurality of points in a depth direction of the sample can be acquired by changing a focal position of the laser light along the depth direction which is the irradiation direction of the laser light with respect to the sample. In this case, at the time of confirming the plurality of acquired Raman spectra, a user cannot easily confirm at which of the plurality of points the Raman spectrum has been acquired.

The present invention has been made in view of the above circumstances, and the present invention provides a Raman microscope that can easily confirm, in the case where Raman spectra have been acquired at a plurality of points in the depth direction, at which of the plurality of points the Raman spectrum has been acquired.

A first aspect of the present invention is a Raman microscope that acquires a Raman spectrum from a sample on a stage by condensing laser light, irradiating the sample with laser light, and receiving Raman scattered light from the sample by a detector, the Raman microscope including a depth measurement processor and a display processor. The depth measurement processor performs depth measurement by changing a focal position of the laser light along the depth direction of the sample which is an irradiation direction of the laser light with respect to the sample, and meanwhile, acquiring the Raman spectrum of the sample at a plurality of points in the depth direction. The display processor causes Raman spectra obtained at the plurality of points by the depth measurement to be displayed. The display processor can display a surface image of the sample on the stage and a depth image representing a plurality of points in the depth direction and causes, in a case where at least one point of the plurality of points in the depth image is selected, the Raman spectrum corresponding to the at least one point to be displayed.

According to the present invention, it is possible to confirm, in the case where the Raman spectra have been acquired at the plurality of points in the depth direction, at which of the plurality of points the Raman spectrum has been acquired.

### BRIEF DESCRIPTION OF THE DRAWINGS

FIG. 1 is a schematic view showing a configuration example of a Raman microscope;

FIG. 2 is a schematic view showing a configuration example of the Raman microscope;

FIG. 3 is a block diagram showing an example of an electrical configuration of the Raman microscope; and

FIG. 4 is a view showing an example of an operation screen displayed on a display unit.

### DETAILED DESCRIPTION OF THE PREFERRED EMBODIMENTS

### 1. Overall Configuration of Raman Microscope

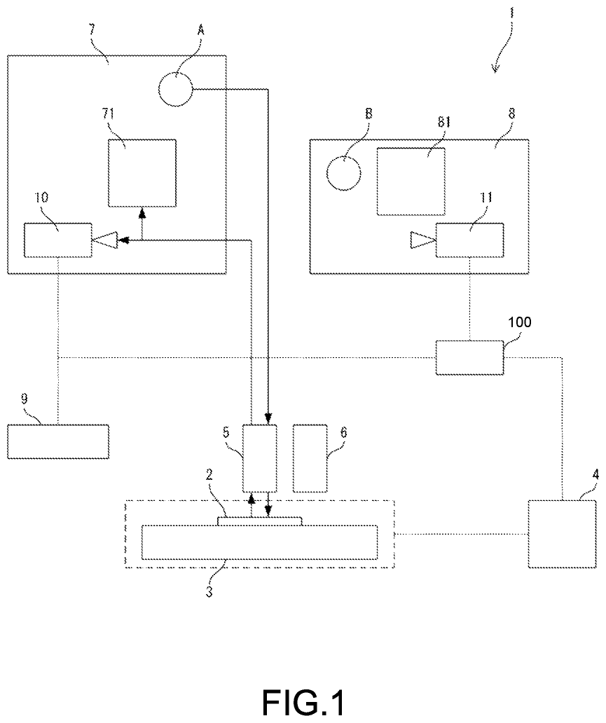

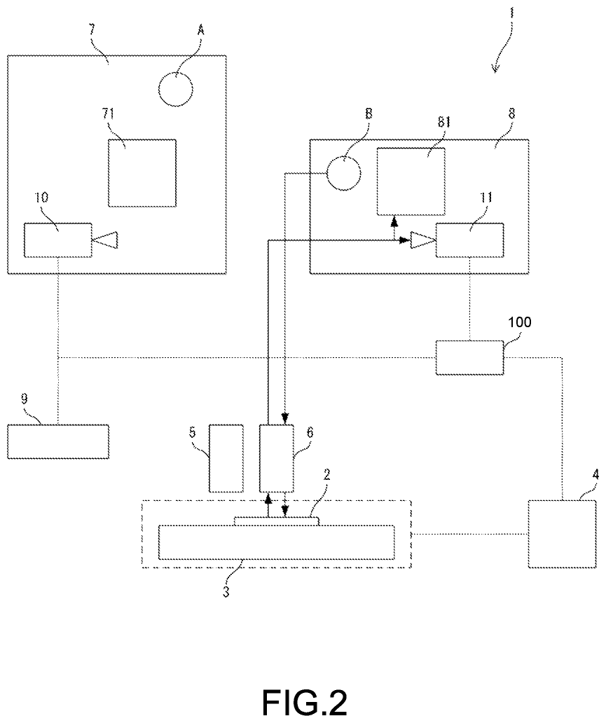

FIGS. 1 and 2 are schematic views each showing a configuration example of a Raman microscope 1. The Raman microscope 1 according to the present embodiment can perform not only Raman spectroscopic analysis but also infrared spectroscopic analysis. FIG. 1 shows a state when the Raman spectroscopic analysis is performed, and FIG. 2 shows a state when the infrared spectroscopic analysis is performed.

The Raman microscope 1 includes a plate 2, a stage 3, a drive unit 4, an objective optical element 5, an objective optical element 6, a Raman light detection system 7, an infrared light detection system 8, a switching mechanism 9, and others. A sample is placed on the stage 3 while being fixed to the plate 2. The stage 3 can be displaced in the horizontal direction or the vertical direction by driving of the drive unit 4. The drive unit 4 includes, for example, a motor and a gear.

The objective optical element 5 is used for the Raman spectroscopic analysis, and has, for example, a configuration in which a convex lens and a concave lens are combined. At the time of performing the Raman spectroscopic analysis, the objective optical element 5 faces the sample on the plate 2 as shown in FIG. 1. That is, the objective optical element 5 is located immediately above the sample on the plate 2.

The objective optical element 6 is used for the infrared spectroscopic analysis, and is, for example, a Cassegrain mirror that has a configuration in which a convex mirror and a concave mirror are combined. At the time of performing the infrared spectroscopic analysis, the objective optical element 6 faces the sample on the plate 2 as shown in FIG. 2. That is, the objective optical element 6 is located immediately above the sample on the plate 2.

The Raman light detection system 7 is used for performing the Raman spectroscopic analysis, and includes a light source A, an optical imaging element 10, and a Raman spectrometer 71. Light emitted from the light source A is, for example, laser light having a wavelength in the visible range or the near-infrared range, and the wavelength thereof is about several micrometers to several tens of micrometers. As shown in FIG. 1, at the time of performing the Raman spectroscopic analysis, the light emitted from the light source A is guided to the objective optical element 5 by various optical elements (not shown).

The light incident on the objective optical element 5 is focused on the sample fixed to the plate 2. That is, the light from the light source A is condensed by being transmitted through the objective optical element 5, and is applied to the focal position on the sample or in the sample. Raman scattered light is generated from the sample irradiated with the light from the light source A, and this light is guided to the Raman light detection system 7 by various optical elements (not shown). A part of the light guided from the objective optical element 5 to the Raman light detection system 7 is incident on the optical imaging element 10, and the remaining light is incident on the Raman spectrometer 71.

The optical imaging element 10 captures a visible image of the sample surface on which the Raman scattered light is generated. The optical imaging element 10 includes, for example, a charge coupled device (CCD) image sensor or a complementary metal oxide semiconductor (CMOS) image sensor, and is configured to be able to capture a still image or a moving image of the sample. The optical imaging element 10 can capture all or at least one of a bright field image, a dark field image, a phase difference image, a fluorescence image, a polarization microscope image, and others of the sample.

The Raman spectrometer 71 detects the intensity for each wavelength by dispersing the Raman scattered light from the sample. Based on a detection signal from the Raman spectrometer 71, a Raman spectrum can be acquired. In the Raman spectrum, the vertical axis represents the intensity, and the horizontal axis represents the wavelength. As described above, in the Raman microscope 1, the Raman spectrum can be acquired by receiving the Raman scattered light from the sample by the detector (the Raman spectrometer 71).

The infrared light detection system 8 is used for performing the infrared spectroscopic analysis, and includes a light source B, an optical imaging element 11, and an infrared spectrometer 81. Light emitted from the light source B is, for example, infrared light emitted from a ceramic heater, and has a wavelength of about 405 nm to 1064 nm, and in many cases, light obtained by combining wavelengths of 532 nm and 785 nm is used. As shown in FIG. 2, at the time of performing the infrared spectroscopic analysis, the light emitted from the light source B is guided to the objective optical element 6 by various optical elements (not shown).

The light incident on the objective optical element 6 is focused on the sample fixed to the plate 2. That is, the light from the light source B is condensed by being transmitted through the objective optical element 6, and is applied to the focal position on the sample or in the sample. Reflected light from the sample irradiated with the light from the light source B is guided to the infrared light detection system 8 by various optical elements (not shown). A part of the light guided from the objective optical element 6 to the infrared light detection system 8 is incident on the optical imaging element 11, and the remaining light is incident on the infrared spectrometer 81.

The optical imaging element 11 captures a visible image of the sample surface on which the infrared light is reflected. The optical imaging element 11 may have a configuration similar to that of the optical imaging element 10. Similarly to the optical imaging element 10, the optical imaging element 11 can capture a still image or a moving image of the sample, and can capture all or at least one of a bright field image, a dark field image, a phase difference image, a fluorescence image, a polarization microscope image, and others of the sample.

The infrared spectrometer 81 is, for example, a Fourier transform infrared spectrometer. The spectrometer included in the infrared spectrometer 81 may be a Michelson interferometer spectrometer. The infrared spectrometer 81 detects the intensity for each wavelength by dispersing the infrared reflected light from the sample. Based on a detection signal from the infrared spectrometer 81, an infrared spectrum can be acquired. In the infrared spectrum, the vertical axis represents the intensity, and the horizontal axis represents the wavelength. As described above, in the Raman microscope 1, the infrared spectrum can be acquired by receiving the infrared reflected light from the sample by the detector (the infrared spectrometer 81).

The switching mechanism 9 switches between the Raman spectroscopic analysis and the infrared spectroscopic analysis. Specifically, the switching mechanism 9 drives the stage 3 by the drive unit 4 to adjust the positional relationship between the objective optical element 5 and the plate 2 and the positional relationship between the objective optical element 6 and the plate 2. In the case of switching to the Raman spectroscopic analysis, the positional relationship between the objective optical element 5 and the plate 2 is adjusted, so that the focal position of the light collected by the objective optical element 5 is adjusted to a predetermined measurement position in the sample. On the other hand, in the case of switching to the infrared spectroscopic analysis, the positional relationship between the objective optical element 6 and the plate 2 is adjusted, so that the focal position of the light collected by the objective optical element 6 is adjusted to a predetermined measurement position in the sample.

### 2. Electrical Configuration of Raman Microscope

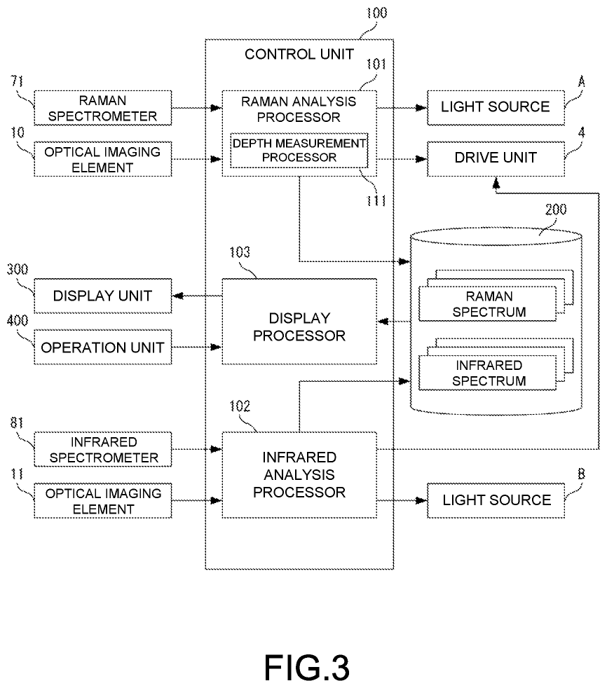

FIG. 3 is a block diagram showing an example of an electrical configuration of the Raman microscope 1. In addition to the constituents described above, the Raman microscope 1 includes a control unit 100, a storage unit 200, a display unit 300, and an operation unit 400.

The control unit 100 includes, for example, a central processing unit (CPU). The control unit 100 functions as a

Raman analysis processor 101, an infrared analysis processor 102, a display processor 103, and the like by the CPU executing a program.

The Raman analysis processor 101 executes processing for performing the Raman spectroscopic analysis on the sample on the stage 3 in a state of being switched to the Raman spectroscopic analysis by the switching mechanism 9. That is, the sample is irradiated with laser light condensed from the light source A, and the Raman spectrum is acquired based on the detection signal from the Raman spectrometer 71. In addition, the Raman analysis processor 101 can acquire a surface image of the sample during the Raman spectroscopic analysis on the basis of the visible image captured by the optical imaging element 10. At the time of the Raman spectroscopic analysis, analysis may be performed while the stage 3 is moved by controlling the drive unit 4.

The infrared analysis processor 102 executes processing for performing the infrared spectroscopic analysis on the sample on the stage 3 in a state of being switched to the infrared spectroscopic analysis by the switching mechanism 9. That is, the sample is irradiated with infrared light condensed from the light source B, and the infrared spectrum is acquired based on the detection signal from the infrared spectrometer 81. In addition, the infrared analysis processor 102 can acquire the surface image of the sample during the infrared spectroscopic analysis on the basis of the visible image captured by the optical imaging element 11. At the time of the infrared spectroscopic analysis, analysis may be performed while the stage 3 is moved by controlling the drive unit 4.

Data during the Raman spectroscopic analysis obtained by processing of the Raman analysis processor 101 and data during the infrared spectroscopic analysis obtained by processing of the infrared analysis processor 102 are stored in the storage unit 200. The storage unit 200 includes, for example, a nonvolatile memory such as a hard disk. The storage unit 200 stores, for example, the Raman spectrum acquired by the Raman spectroscopic analysis and the infrared spectrum acquired by the infrared spectroscopic analysis.

The display processor 103 controls display on the display unit 300. That is, under the control of the display processor 103, various screens such as an operation screen are displayed on a display screen of the display unit 300. The display unit 300 includes, for example, a liquid crystal display, but is not limited thereto. The Raman spectrum or the infrared spectrum stored in the storage unit 200 can be displayed on the display screen of the display unit 300 under the control of the display processor 103.

The operation unit 400 is provided for a user to perform an input operation, and includes, for example, a keyboard or a mouse, but is not limited thereto. When the operation screen is displayed on the display unit 300, the input operation on the operation screen can be performed by operating the operation unit 400. When the input operation is performed using the operation unit 400, input information (such as a numerical value) is reflected and displayed on the operation screen of the display unit 300.

In the present embodiment, the Raman analysis processor 101 includes a depth measurement processor 111. The depth measurement processor 111 controls the drive unit 4 during the Raman spectroscopic analysis to acquire Raman spectra at a plurality of points while moving the stage 3 in the vertical direction, thereby performing depth measurement. That is, at the time of depth measurement, the distance between the sample and the objective optical element 5 changes as the stage 3 moves in the vertical direction.

Because the focal position of the laser light from the objective optical element 5 toward the sample is constant, the focal position of the laser light with respect to the sample changes with the movement of the stage 3 at the time of depth measurement. That is, the focal position of the laser light with which the sample is irradiated at the time of depth measurement is not only on the sample but also inside the sample.

Specifically, in the depth measurement, the focal position of the laser light is changed along the depth direction which is the irradiation direction (optical axis direction) of the laser light with respect to the sample, and meanwhile, the Raman spectrum is acquired based on the detection signals detected at a predetermined interval from the Raman spectrometer 71. As a result, the Raman spectrum based on the detection signal from the Raman spectrometer 71 is acquired at each of the plurality of points separated at the predetermined interval in the depth direction. The predetermined interval can be set in advance by the user.

The display processor 103 can cause the display unit 300 to display the Raman spectra acquired by the depth measurement at the plurality of points. In addition, the display processor 103 may be able to cause the display unit 300 to display various screens such as an input screen used for inputting parameters for performing the depth measurement. The parameter includes, in addition to the predetermined interval, a range in the depth direction in which the depth measurement is performed, a diameter (spot diameter) of the laser light on the surface image of the sample, and others. The depth measurement processor 111 performs the depth measurement on the basis of the parameters input to the input screen.

### 3. Specific Example of Operation Screen

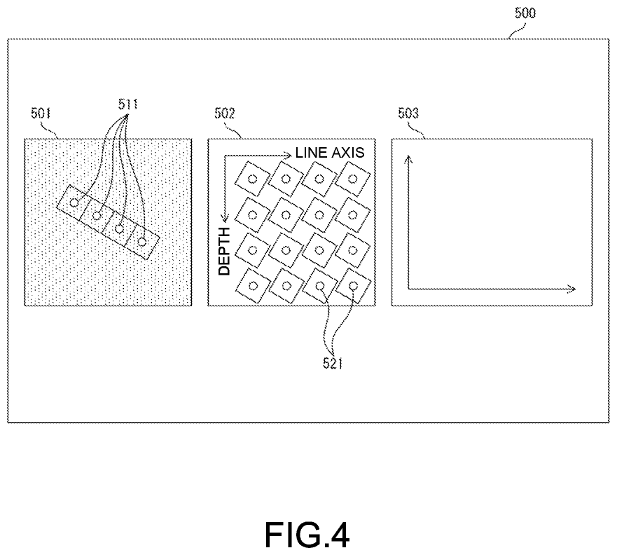

FIGS. 4 is a view showing an example of an operation screen 500 displayed on the display unit 300. The operation screen 500 includes a surface image display region 501, a depth image display region 502, and a spectrum display region 503. However, all of the surface image display region 501, the depth image display region 502, and the spectrum display region 503 are not limited to a display mode included in the operation screen 500, and at least one of the above may be displayed on a screen different from the operation screen 500.

The surface image of the sample on the stage 3 is displayed in the surface image display region 501. That is, the visible image captured by the optical imaging element 10 is displayed in the surface image display region 501. The surface image of the sample displayed in the surface image display region 501 may be a real-time image captured by the optical imaging element 10 or a still image captured at a predetermined timing. When the stage 3 is moved in the horizontal direction (direction intersecting the depth direction), a region of the surface image of the sample displayed in the surface image display region 501 may be changed.

The user can select the measurement position on the surface image of the sample. The measurement position is an optional position selected in the horizontal plane, and the depth measurement is performed along the depth direction at the selected measurement position.

Only one measurement position may be selected, or a plurality of measurement positions may be selected. The example in FIG. 4 shows a case where four measurement positions 511 are selected and the depth measurement is performed. The plurality of measurement positions 511 are selected so as to be aligned on a straight line. The measurement position 511 is selected by an operation on the operation unit 400, but any method can be used for selecting the measurement position 511. For example, in a case where the operation unit 400 includes a pointing device such as a mouse, the plurality of measurement positions 511 can be easily selected by a drag operation or the like. The distance between the plurality of measurement positions 511 in the horizontal direction may be constant or may not be constant.

The light source A in the Raman light detection system 7 may be able to emit laser light at a plurality of wavelengths. In this case, the measurement position selected on the surface image of the sample displayed in the surface image display region 501 may be selectable for each wavelength.

In the depth image display region 502, a depth image in which a plurality of points in the depth direction are associated with each measurement position 511 is displayed. The depth image is a two-axis display of a direction (line axis) in which the measurement positions 511 are aligned on a straight line in the horizontal plane and the depth direction at the time of performing the depth measurement, and is a mapping image for displaying, in a visually easy-to-understand manner, the relative positions of a plurality of points 521 in the depth direction in association with the measurement positions 511. The user can select the optional point 521 on this depth image. In this example, the depth image is displayed such that the line axis and the depth direction are orthogonal to each other, but a display mode in which the line axis and the depth direction are not orthogonal to each other may be used. Furthermore, the depth image is not limited to the two-axis display, and the plurality of points 521 in the depth direction can be displayed in an easy-to-understand manner in another optional mode.

In this example, a depth image representing the plurality of points 521 in the depth direction is displayed in the depth image display region 502 in association with each of the four measurement positions 511 selected on the surface image of the sample. The number of points 521 in the depth direction varies depending on a value set as a parameter at the time of performing the depth measurement. That is, the number of points 521 displayed in association with each measurement position 511 in the depth image display region 502 is different according to a range in the depth direction at the time of performing the depth measurement and the interval between the plurality of points in the depth direction.

The distance between the points 521 arranged on the line axis (horizontal axis) in the depth image display region 502 may or may not change depending on the actual distance between the plurality of measurement positions 511 selected on the surface image of the sample. Similarly, the distance between the points 521 arranged on the depth axis (vertical axis) in the depth image display region 502 may or may not change according to the actual interval between the plurality of points at the time of depth measurement. When one measurement position 511 is selected on the surface image of the sample, one point 521 is displayed on the line axis (horizontal axis), and the plurality of points 521 are displayed in one column on the depth axis (vertical axis).

By the user selecting at least one point 521 of the plurality of points displayed on the depth image display region 502, the Raman spectrum corresponding to the desired point 521 can be displayed on the spectrum display region 503. That is, when at least one point 521 of the plurality of points in the depth image is selected, the display processor 103 causes the Raman spectrum corresponding to that point to be displayed in the spectrum display region 503.

If there is one selected point 521, the Raman spectrum acquired at the time of depth measurement at that selected point 521 is displayed in the spectrum display region 503. On the other hand, if there are a plurality of the selected points 521, the Raman spectra acquired at the time of depth measurement at each of the points 521 may be displayed side by side, partially or entirely superimposed, or may be optionally selected by the user and displayed.

Although only the case of the Raman spectroscopic analysis has been described in the above embodiment, the infrared spectrum acquired by the infrared spectroscopic analysis may be displayed together on the operation screen 500. In this case, for example, in the surface image display region 501, the measurement position of the infrared spectroscopic analysis may be displayed in a different display mode so as to be distinguishable from the measurement position 511 of the Raman spectroscopic analysis.

### 4. Aspects

It is understood by those skilled in the art that the plurality of exemplary embodiments described above are specific examples of the following aspects.

(Item 1) A Raman microscope according to one aspect is a Raman microscope that acquires a Raman spectrum from a sample on a stage by condensing laser light, irradiating the sample with the laser light, and receiving Raman scattered light from the sample by a detector, the Raman microscope including:

a depth measurement processor that performs depth measurement by changing a focal position of the laser light along a depth direction of the sample which is an irradiation direction of the laser light with respect to the sample, and meanwhile, acquiring the Raman spectrum of the sample at a plurality of points in the depth direction; and

a display processor that causes Raman spectra obtained at the plurality of points by the depth measurement to be displayed,

in which the display processor can display a surface image of the sample on the stage and a depth image representing a plurality of points in the depth direction and causes, in a case where at least one point of the plurality of points in the depth image is selected, the Raman spectrum corresponding to the at least one point to be displayed.

According to the Raman microscope described in item 1, when the Raman spectra at the plurality of points in the depth direction are acquired, the plurality of points in the depth direction can be represented in an easy-to-understand manner by the depth image. Therefore, by selecting at least one point of the plurality of points in the depth image and displaying the Raman spectrum corresponding to the at least one point, it is possible to easily confirm at which point of the plurality of points the Raman spectrum has been acquired.

(Item 2) In the Raman microscope according to item 1,

the depth measurement processor may be able to change, at a plurality of measurement positions on the surface image, the focal position of the laser light along the depth direction, and meanwhile, acquire the Raman spectra at the plurality of points in the depth direction, and

in the depth image, the plurality of points in the depth direction may be represented in association with each of the plurality of measurement positions.

According to the Raman microscope described in item 2, even in the case where the Raman spectra at the plurality of points in the depth direction are acquired in the plurality of measurement positions on the surface image, the plurality of points in the depth direction can be represented in an easy-to-understand manner by the depth image.

(Item 3) In the Raman microscope according to item 2,

the plurality of measurement positions may be selected to be aligned on a straight line on the surface image, and

in the depth image, the plurality of points in the depth direction may be represented in association with each of the plurality of measurement positions by two-axis display of a direction in which the plurality of measurement positions are aligned and the depth direction.

According to the Raman microscope described in item 3, even in the case where the Raman spectra at the plurality of points in the depth direction are acquired in the plurality of measurement positions on the surface image, the plurality of points in the depth direction can be represented in an easy-to-understand manner by the depth image represented by the two-axis display of the direction in which the plurality of measurement positions are aligned and the depth direction.

What is claimed is:

1. A Raman microscope that acquires a Raman spectrum from a sample on a stage by condensing laser light, irradiating the sample with the laser light, and receiving Raman scattered light from the sample by a detector, the Raman microscope comprising:
a depth measurement processor that performs depth measurement by changing a focal position of the laser light along a depth direction of the sample which is an irradiation direction of the laser light with respect to the sample, and meanwhile, acquiring the Raman spectrum of the sample at a plurality of points in the depth direction; and
a display processor that causes Raman spectra obtained at the plurality of points by the depth measurement to be displayed,
wherein the display processor can display a surface image of the sample on the stage and a depth image representing a plurality of points in the depth direction and causes, in a case where at least one point of the plurality of points in the depth image is selected, the Raman spectrum corresponding to the at least one point to be displayed.

2. The Raman microscope according to claim 1, wherein
the depth measurement processor can change, at a plurality of measurement positions on the surface image, the focal position of the laser light along the depth direction, and meanwhile, acquire the Raman spectra at the plurality of points in the depth direction, and
in the depth image, the plurality of points in the depth direction are represented in association with each of the plurality of measurement positions.

3. The Raman microscope according to claim 2, wherein
the plurality of measurement positions are selected to be aligned on a straight line on the surface image, and
in the depth image, the plurality of points in the depth direction are represented in association with each of the plurality of measurement positions by two-axis display of a direction in which the plurality of measurement positions are aligned and the depth direction.
